(19) United States
(12) Patent Application Publication
(10) Pub. No.: US 2026/0156514 A1
(43) Pub. Date: Jun. 4, 2026

(54) BEAM REPORTING METHOD AND APPARATUS FOR INITIAL BEAM PAIRING IN SIDELINK COMMUNICATION

(71) Applicant: Intellectual Discovery Co., Ltd., Seoul (KR)

(72) Inventor: Hyuk Min SON, Seoul (KR)

(21) Appl. No.: 19/461,835

(22) Filed: Jan. 28, 2026

Related U.S. Application Data
(63) Continuation of application No. PCT/KR2024/010804, filed on Jul. 25, 2024.

(30) Foreign Application Priority Data
Aug. 4, 2023 (KR) 10-2023-0102103
Jul. 23, 2024 (KR) 10-2024-0096978

(51) Int. Cl. H04W 24/10; H04W 72/25; H04W 92/18

(52) U.S. Cl. CPC H04W 24/10; H04W 72/25; H04W 92/18

(57) ABSTRACT

Methods and apparatus for beam reporting in sidelink communication are described. According to one embodiment, a receiving terminal receives a reference signal (RS) or a direct link establishment request message from a transmitting terminal. Thereafter, the receiving terminal determines a transmission beam of the transmitting terminal and a reception beam of the receiving terminal based on the received reference signal or direct link establishment request message, and transmits beam reporting including information about the transmission beam of the transmitting terminal or the reception beam of the receiving terminal, wherein a resource on which the beam reporting is transmitted is associated with the transmission beam or a reception beam of the transmitting terminal.

### CROSS-REFERENCE TO RELATED APPLICATIONS

This application is a continuation of PCT Application No. PCT/KR2024/010804 filed on Jul. 25, 2024, which claims priority to Korean Patent Application No. 10-2023-0102103 filed on Aug. 4, 2023, and Korean Patent Application No. 10-2024-0096978 filed on Jul. 23, 2024, the disclosures of which are incorporated herein by reference.

### BACKGROUND OF THE DISCLOSURE

### Technical Field

The present disclosure relates to 3GPP 5G sidelink communication.

### Background Art

As an increasing number of communication devices demand greater communication traffic over time, a next-generation 5G system, which is an enhanced wireless broadband communication system compared to the conventional LTE system, is required. In this next-generation 5G system, also referred to as NewRAT, communication scenarios are classified into Enhanced Mobile Broadband (eMBB), Ultra-Reliability and Low-Latency Communication (URLLC), Massive Machine-Type Communications (mMTC), and so on.

Here, the eMBB is a next-generation mobile communication scenario that has characteristics such as High Spectrum Efficiency, High User Experienced Data Rate, and High Peak Data Rate. The URLLC is a next-generation mobile communication scenario characterized by features such as Ultra Reliability, Ultra Low Latency, and Ultra High Availability (e.g., V2X, Emergency Service, Remote Control). The mMTC is a next-generation mobile communication scenario characterized by features such as Low Cost, Low Energy, Short Packet, and Massive Connectivity (e.g., IoT).

### SUMMARY OF THE DISCLOSURE

The present disclosure is to provide a beam reporting method and apparatus for initial beam pairing in sidelink communication.

An embodiment of the present specification provides a method in which, in sidelink (SL) communication, a receiving terminal receives a reference signal (RS) or a direct link establishment request message from a transmitting terminal. Thereafter, the receiving terminal determines a transmission beam of the transmitting terminal and a reception beam of the receiving terminal based on the received reference signal or direct link establishment request message, and transmits beam reporting that includes information about the transmission beam of the transmitting terminal or the reception beam of the receiving terminal, wherein a resource on which the beam reporting is transmitted is associated with the transmission beam or a reception beam of the transmitting terminal.

Further, an embodiment of the present specification provides a method in which, in sidelink (SL) communication, a transmitting terminal transmits a reference signal (RS) or a direct link establishment request message to a receiving terminal. Thereafter, the transmitting terminal receives beam reporting that includes information about a transmission beam of the transmitting terminal or a reception beam of the receiving terminal, which is determined based on the transmitted reference signal or direct link establishment request message, wherein a resource on which the beam reporting is received is associated with the transmission beam or a reception beam of the transmitting terminal.

Further, an embodiment of the present specification provides a transmitting terminal for sidelink (SL) communication, comprising a control unit and a memory unit storing instructions and operably and electrically connected with the control unit, wherein operations performed based on the instructions, when executed by the control unit, comprise: receiving a reference signal (RS) or a direct link establishment request message from a transmitting terminal, determining a transmission beam of the transmitting terminal and a reception beam of the receiving terminal based on the received reference signal or direct link establishment request message, and transmitting beam reporting that includes information about the transmission beam of the transmitting terminal or the reception beam of the receiving terminal, wherein the resource on which the beam reporting is transmitted is associated with the transmission beam or a reception beam of the transmitting terminal.

Further, an embodiment of the present specification provides a receiving terminal for sidelink (SL) communication, comprising a control unit and a memory unit storing instructions and operably and electrically connected with the control unit, wherein operations performed based on the instructions, when executed by the control unit, comprise: transmitting a reference signal (RS) or a direct link establishment request message to a receiving terminal, and receiving beam reporting that includes information about a transmission beam of the transmitting terminal or a reception beam of the receiving terminal, which is determined based on the transmitted reference signal or direct link establishment request message, wherein a resource on which the beam reporting is received is associated with the transmission beam or a reception beam of the transmitting terminal.

The resource on which the beam reporting is transmitted may be resource pool specific or terminal specific.

Meanwhile, the beam reporting may be repeatedly transmitted from the receiving terminal and received by the transmitting terminal. That is, the beam reporting may be repeatedly transmitted via the resource on which the beam reporting is transmitted.

On the other hand, the beam reporting may be transmitted and received via a physical sidelink control channel (PSCCH), a physical sidelink shared channel (PSSCH), or a physical sidelink feedback channel (PSFCH). Here, the beam reporting transmitted via the PSCCH or the PSSCH may be in a message format, and the beam reporting transmitted via the PSFCH may be in a sequence format.

According to the disclosure of the present specification, beam reporting for initial beam pairing for sidelink communication in the 3GPP 5G frequency range 2 (FR2) band can be efficiently performed.

### BRIEF DESCRIPTION OF THE DRAWINGS

FIG. 1 is a diagram illustrating a New Radio (NR) wireless communication system.

FIG. 2 illustrates a structure of a radio frame used in the NR.

FIG. 3 illustrates a slot structure of an NR frame.

FIG. 4 illustrates an example of a Next Generation Radio Access Network (NG-RAN) architecture that supports a PC5 interface.

FIGS. 5A to 5B illustrate procedures for performing sidelink communication according to a sidelink resource allocation mode.

FIGS. 6A to 6B are examples illustrating resource allocation for beam reporting according to an embodiment of this specification.

FIG. 7 is an example of signaling for beam reporting for initial beam pairing according to an embodiment of this specification.

FIG. 8 illustrates a wireless communication apparatus according to an embodiment of the present specification.

### DETAILED DESCRIPTION OF THE DISCLOSURE

Although embodiments are described herein using an LTE system, an LTE-A system, and an NR system, these embodiments may be applied to any communication system corresponding to the above definitions.

Furthermore, in the present specification, the term ‘base station’ may be used as a comprehensive term that includes a remote radio head (RRH), an eNB, a transmission point (TP), a reception point (RP), a relay, and the like.

3GPP-based communication standards define downlink physical channels corresponding to resource elements that carry information originating from a higher layer, and downlink physical signals corresponding to resource elements that are used by the physical layer but do not carry information originating from a higher layer. For example, the physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as downlink physical channels, and a reference signal and a synchronization signal are defined as downlink physical signals. A reference signal (RS), also referred to as a pilot, means a predefined special waveform signal known to both a gNB and a UE. For example, cell-specific RS, UE-specific RS (UE-RS), positioning RS (PRS), and channel state information RS (CSI-RS) are defined as downlink reference signals. 3GPP LTE/LTE-A standards define uplink physical channels corresponding to resource elements that carry information originating from a higher layer, and uplink physical signals corresponding to resource elements that are used by the physical layer but do not carry information originating from a higher layer. For example, the physical uplink shared channel (PUSCH), physical uplink control channel (PUCCH), and physical random access channel (PRACH) are defined as uplink physical channels, and a demodulation reference signal (DMRS) for uplink control/data signals and a sounding reference signal (SRS) used for uplink channel measurement are defined.

In this specification, Physical Downlink Control Channel (PDCCH)/Physical Control Format Indicator Channel (PCFICH)/Physical Hybrid automatic retransmit request Indicator Channel (PHICH)/Physical Downlink Shared Channel (PDSCH) respectively mean a set of time-frequency resources or a set of resource elements carrying Downlink Control Information (DCI)/Control Format Indicator (CFI)/downlink ACKnowledgement/Negative ACK (ACK/NACK)/downlink data. Furthermore, Physical Uplink Control Channel (PUCCH)/Physical Uplink Shared Channel (PUSCH)/Physical Random Access Channel (PRACH) respectively mean a set of time-frequency resources or a set of resource elements carrying Uplink Control Information (UCI)/uplink data/random access signals.

Meanwhile, an NR frequency band may be defined with two types of frequency ranges (FR1 and FR2). The numerical values of the frequency ranges may be changed. For example, the two types of frequency ranges (FR1 and FR2) may be as shown in Table 1 below. For convenience of description, among the frequency ranges used in the NR system, FR1 may mean a “sub 6 GHz range”, and FR2 may mean an “above 6 GHz range” and may be called a millimeter wave (mmW).

TABLE 1

| Frequency Range | Corresponding frequency | | |
|---|---|---|---|
| designation | range | Subcarrier Spacing | |
| FR1 | 410 MHz-7125 MHz | 15, 30, 60 | kHz |
| FR2 | 24250 MHz-52600 MHz | 60, 120, 240 | kHz |

The numerical values of the frequency range of the NR system may be changed. For example, FR1 may include a band from 410 MHz to 7125 MHz as in Table 1. That is, FR1 may include a frequency band of 6 GHz (or 5850, 5900, 5925 MHZ, etc.) or higher. For example, the frequency band of 6 GHz (or 5850, 5900, 5925 MHz, etc.) or higher included in FR1 may include an unlicensed band. The unlicensed band may be used for various purposes, for example, for communication for vehicles (e.g., autonomous driving).

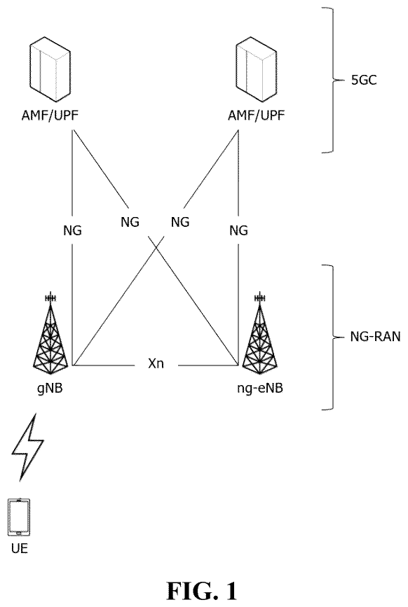

FIG. 1 is a diagram illustrating an NR wireless communication system.

Referring to FIG. 1, the NR wireless communication system may be classified into a 5G core network (5GC) and a next generation-radio access network (NG-RAN), and the NG-RAN may include base stations (gNB and/or ng-eNB) that provide user plane and control plane protocol termination to a user equipment (UE). A gNB (next generation-Node B) provides NR user plane and control plane protocol termination to the UE, and an ng-eNB (next generation-evolved Node B) provides evolved-universal terrestrial radio access (E-UTRA) user plane and control plane protocol termination to the UE. The user equipment (UE) may be fixed or have mobility, and may be called by other terms such as mobile station (MS), user terminal (UT), subscriber station (SS), mobile terminal (MT), or wireless device. The base station (gNB and/or ng-eNB) may be a fixed station that communicates with the UE, and may be called by other terms such as base transceiver system (BTS), access point, etc.

The base stations (gNB and/or ng-eNB) may be connected to each other via an Xn interface, and may be connected to a 5G core network (5GC) via an NG interface. Specifically, the base stations (gNB and/or ng-eNB) may be connected to an access and mobility management function (AMF) via an NG-C interface, and may be connected to a user plane function (UPF) via an NG-U interface.

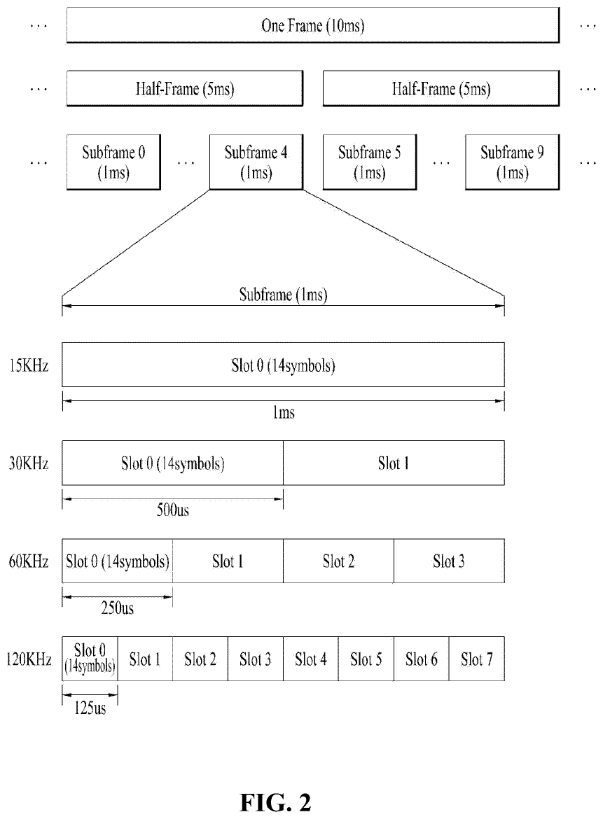

FIG. 2 illustrates a structure of a radio frame used in NR.

In NR, uplink and downlink transmissions are composed of frames. A radio frame has a length of 10 ms and is defined by two 5 ms Half-Frames (HFs). A half-frame is defined by five 1 ms subframes (SFs). A subframe is divided into one or more slots, and the number of slots within a subframe depends on the subcarrier spacing (SCS). Each slot includes 12 or 14 OFDM (A) symbols depending on the cyclic prefix (CP). In the case of normal CP, each slot includes 14 symbols. In the case of extended CP, each slot includes 12 symbols. Here, a symbol may include an OFDM symbol (or CP-OFDM symbol) or an SC-FDMA symbol (or DFT-s-OFDM symbol).

Table 2 illustrates that when normal CP is used, the number of symbols per slot, the number of slots per frame, and the number of slots per subframe vary depending on the SCS.

TABLE 2

| | | | |
|---|---|---|---|
| SCS(15*2^{u}) | N^{slot}_{symb} | N^{frame, u}ₛₗₒₜ | N^{subframe, u}ₛₗₒₜ |

| | | | | |
|---|---|---|---|---|
| 15 | KHz(u = 0) | 14 | 10 | 1 |
| 30 | KHz(u = 1) | 14 | 20 | 2 |
| 60 | KHz(u = 2) | 14 | 40 | 4 |
| 120 | KHz(u = 3) | 14 | 80 | 8 |
| 240 | KHz(u = 4) | 14 | 160 | 16 |

N^{slot}_{symb}: number of symbols in a slot
N^{frame,u}ₛₗₒₜ: number of slots in a frame
N^{subframe,u}ₛₗₒₜ: number of slots in a subframe

Table 3 illustrates that when extended CP is used, the number of symbols per slot, the number of slots per frame, and the number of slots per subframe vary depending on the SCS.

TABLE 3

| SCS (15*2^{u}) | N^{slot}_{symb} | N^{frame, μ}ₛₗₒₜ | N^{subframe, μ}ₛₗₒₜ |
|---|---|---|---|
| 60 KHz (u = 2) | 12 | 40 | 4 |

In an NR system, OFDM (A) numerology (e.g., SCS, CP length, etc.) may be set differently among a plurality of cells that are aggregated for a single UE. Accordingly, the (absolute time) duration of a time resource (e.g., SF, slot, or TTI) composed of the same number of symbols (collectively referred to as a Time Unit (TU) for convenience) may be set differently among the aggregated cells.

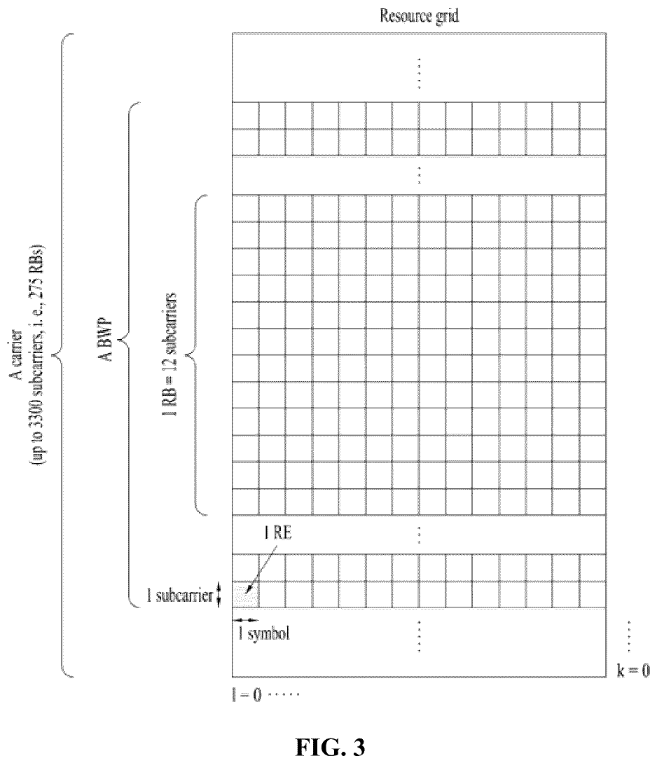

FIG. 3 illustrates a slot structure of an NR frame.

A slot includes a plurality of symbols in the time domain. For example, in the case of normal CP, one slot includes 14 symbols, but in the case of extended CP, one slot includes 12 symbols. A carrier includes a plurality of subcarriers in the frequency domain. A resource block (RB) is defined by a plurality of (e.g., 12) consecutive subcarriers in the frequency domain. A bandwidth part (BWP) is defined by a plurality of consecutive (P) RBs in the frequency domain, and may correspond to one numerology (e.g., SCS, CP length, etc.). A carrier may include up to N (e.g., 4) BWPs. Data communication is performed through an activated BWP, and only one BWP may be activated for one UE. Each element in a resource grid is referred to as a Resource Element (RE), and one complex symbol may be mapped to it.

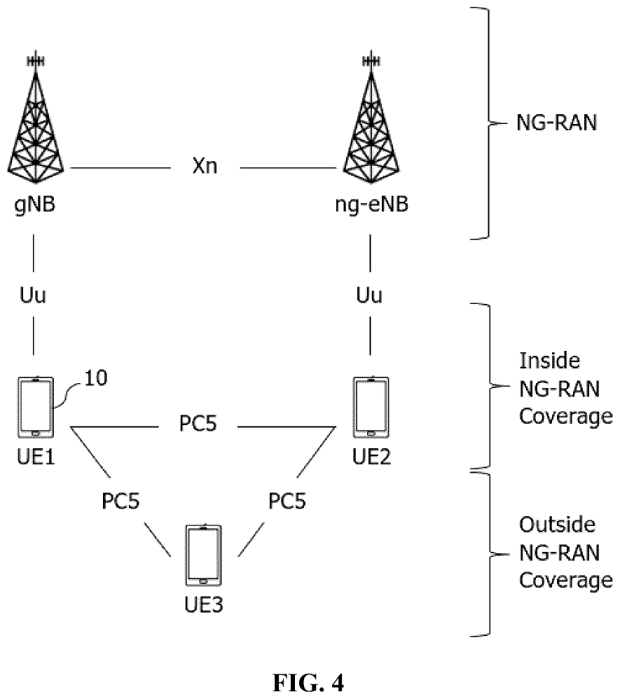

FIG. 4 illustrates an example of an NG-RAN architecture that supports a PC5 interface.

Referring to FIG. 4, the next generation-radio access network (NG-RAN) architecture supports the PC5 interface. Sidelink transmission and reception via the PC5 interface are supported both when the user equipment (UE) is inside NG-RAN coverage and when the UE is outside NG-RAN coverage, regardless of the radio resource control (RRC) state of the UE.

Vehicle-to-Everything (V2X) service support via the PC5 interface may be provided by NR sidelink communication and/or V2X sidelink communication. NR sidelink communication may also be used to support services other than V2X services.

NR sidelink communication may support one type among a unicast transmission mode, a groupcast transmission mode, and a broadcast transmission mode. In the case of unicast type sidelink communication, a UE may perform one-to-one communication with another UE. In the case of groupcast type sidelink communication, a UE may perform sidelink communication with one or more UEs within a group to which it belongs.

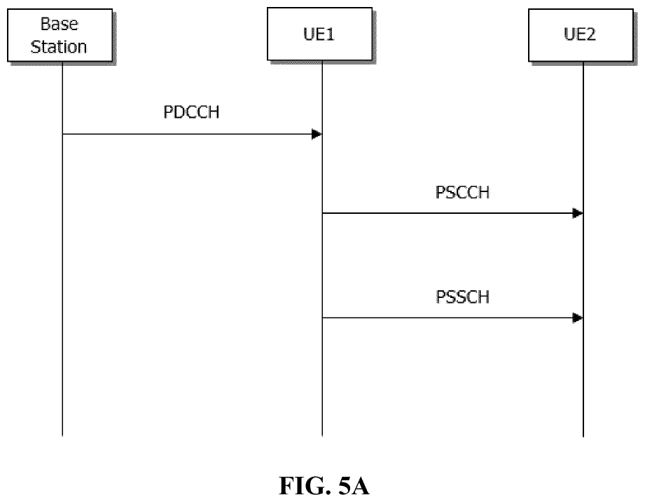

FIGS. 5A to 5B illustrate procedures for performing sidelink communication according to a sidelink resource allocation mode.

FIG. 5A illustrates a UE operation related to NR resource allocation mode 1, and FIG. 5B illustrates a UE operation related to NR resource allocation mode 2.

Referring to FIG. 5A, in NR resource allocation mode 1, a base station may schedule sidelink (SL) resources to be used by a user equipment (UE) for SL transmission. For example, the base station may perform resource scheduling for UE1 using a downlink control channel (DCI) transmitted via a physical downlink control channel (PDCCH), and UE1 may perform V2X or SL communication with UE2 according to the resource scheduling. For example, UE1 may transmit sidelink control information (SCI) to UE2 via the physical sidelink control channel (PSCCH), and then transmit SL data to UE2 via the physical sidelink shared channel (PSSCH) based on the SCI.

Referring to FIG. 5B, in NR resource allocation mode 2, a user equipment (UE) may determine a sidelink (SL) transmission resource within an SL resource configured by a base station or a pre-configured SL resource. For example, the configured SL resource or pre-configured SL resource may be a sidelink resource pool. For example, the UE may autonomously select or schedule a resource for SL transmission. That is, a UE may perform SL communication by autonomously selecting a resource within a configured resource pool. Furthermore, the UE may perform a sensing and resource (re) selection procedure to autonomously select a resource within a selection window. For example, the sensing may be performed on a sub-channel basis. As shown in FIG. 5B, UE1, which has autonomously selected a resource within the resource pool, may transmit SCI to UE2 via the PSCCH, and then transmit data based on the SCI to UE2 via the PSSCH.

The beam reporting method during initial beam pairing may vary depending on beam correspondence. Furthermore, the resource allocation method for beam reporting and its operation method may vary depending on whether the beam reporting is transmitted in a message or sequence format. This matter is currently under discussion at standardization meetings, and nothing has been decided. Therefore, this specification conducts development on the above content and proposes a related solution.

In this specification, for convenience of explanation, this specification refers to UE1 as a terminal that transmits a data/signal in sidelink (SL) communication, and refers to UE2 as a target terminal that receives the data/signal from UE1. Furthermore, the transmission beam used for data/signal transmission is referred to as a Tx beam, and the reception beam used for data/signal reception is referred to as an Rx beam. This specification proposes a transmission and operation method for UE2 to report beam information about UE1 measured during the performance of initial beam pairing and unicast link establishment operations for sidelink (SL) communication in the frequency range 2 (FR2) band.

To perform the initial beam pairing and unicast link establishment operations, UE1 may transmit a reference signal (RS) and/or a direct link establishment request message in a beam sweeping manner. A direct communication request (DCR) may initiate the process of the direct link establishment request. It is appreciated that the direct communication request (DCR) may be used interchangeably with the direct link establishment request. Thereafter, through receiving the corresponding RS or direct link establishment request message, UE2 may select one or more of UE1's Tx beams used by UE1 that are available for SL communication and one or more Rx beams that UE2 may use. That is, UE2 may obtain a pair of a Tx beam of UEL and a corresponding Rx beam of UE2. After performing the above operation, UE2 must transmit the obtained Tx beam information of UEL and information associated with the beam pair, for example, beam quality information such as L1-RSRP (layer 1-reference signal received power), to UE1, and a process of transmitting the corresponding information, that is, beam reporting, is required.

This specification proposes an operation method in which UE2 reports beam information acquired through the two operational processes to UE1, regardless of the order in which the initial beam pairing operation and the unicast link establishment operation are performed.

This specification provides a description by distinguishing between the case where the signal transmitted by UE2 during beam reporting for initial beam pairing is in a message format and transmitted via a physical sidelink control channel (PSCCH) and a physical sidelink shared channel (PSSCH), and the case where it is transmitted in a sequence format. The case of performing beam reporting in a sequence format includes the case of transmitting the corresponding sequence via a physical sidelink feedback channel (PSFCH).

First Disclosure: A Case where Beam-Related Information is Transmitted in a Message Format During Beam Reporting

At the time of beam reporting in the initial beam pairing stage, it is a situation in which UE1 does not know information related to a beam for transmitting and receiving with UE2. Depending on the presence or absence of beam correspondence between the sidelink transmitted from UE1 to UE2 and the sidelink transmitted from UE2 to UE1, the following two methods may be applied for transmitting and receiving message-format beam reporting. For convenience of explanation, the sidelink transmitted from UE1 to UE2 is referred to as SL1, and the sidelink transmitted from UE2 to UE1 is referred to as SL2.

1) Beam Reporting Method when there is No Beam Correspondence Between SL1 and SL2

The beam information measured and obtained by UE2 from a signal and/or message transmitted via SL1 for initial beam pairing may be Tx beam information of UEL and Rx beam information of UE2. Both UE2 and UE1 are in a state of not having information about the Tx beam of UE2 for beam reporting transmission and the Rx beam of UEL for beam reporting reception. Therefore, beam reporting may be performed in the following manner.

A specific resource region may be configured for the beam reporting transmitted by UE2, and within that specific resource region, UE2 may repeatedly transmit a beam reporting message in a beam sweeping manner. At this time, if a beam reporting message is successfully received during the process of UE1 receiving the beam reporting message in a beam sweeping manner, UE1 may acquire information about an Rx beam of UE1. Furthermore, through performing beam reporting message decoding, information about a Tx beam of UE1 may be acquired. The Tx beam information of UE1 included in the beam reporting message may be resource region information where the corresponding signal and/or message was transmitted, when UE2 attempts to receive the signal and/or message transmitted by UE1 via SL1 in a beam sweeping manner and succeeds in reception. Alternatively, it may be a Tx beam index of UE1 associated with the corresponding resource region.

In the above process, each beam reporting transmission resource within the resource region configured for the beam reporting transmitted by UE2 may be operated in association with a Tx beam of UE1. In this case, upon receiving the beam reporting message, UE1 may be operated to acquire Tx beam information of UE corresponding to the specific resource region where the message was transmitted.

Thereafter, a signal and/or message transmitted by UE1 via SL1 may be transmitted including Tx beam information of UE2, and UE2, which has received the signal and/or message, may acquire the Tx beam information of UE2. At this time, the Tx beam information of UE2 may be resource region information where UE1 successfully received the beam reporting message or a Tx beam index of UE2 associated with the corresponding resource region.

2) Beam Reporting Method when there is Beam Correspondence Between SL1 and SL2

The beam information measured and obtained by UE2 from a signal and/or message transmitted via SL1 for initial beam pairing may be Tx beam information of UEL and Rx beam information of UE2. If beam correspondence exists, the previously obtained Rx beam of UE2 may be applied as the Tx beam of UE2 used when transmitting the beam reporting message via SL2. Alternatively, a Tx beam of UE2 may be set based on the corresponding Rx beam information of UE2.

A specific resource region is configured for the beam reporting transmitted by UE2, and within that specific resource region, UE2 may transmit the beam reporting message once or more times repeatedly with the Tx beam obtained in the above process.

At this time, in the case of a resource for beam reporting transmission, it may be associated with a Tx beam and/or Rx beam of UE1 for each resource region. In this case, upon receiving the beam reporting message, UE1 may attempt reception using an Rx beam corresponding to the specific resource region where the message was transmitted. Alternatively, in the resource region where the beam reporting message is repeatedly transmitted, UE1 may attempt reception in a beam sweeping manner.

If the beam reporting message is successfully received, UE1 may acquire information about an Rx beam of UE1. The corresponding Rx beam information may be applied and used as a Tx beam of UE1. Alternatively, a Tx beam of UE1 may be set based on the corresponding Rx beam information.

Furthermore, information about the Tx beam(s) of UE1 may be additionally acquired or confirmed through performing beam reporting message decoding.

The Tx beam information of UE1 included in the beam reporting message may be resource region information where the corresponding signal and/or message was transmitted, when UE2 attempts to receive the signal and/or message transmitted by UE1 via SL1 in a beam sweeping manner and succeeds in reception. Alternatively, it may be a Tx beam index of UEL associated with the corresponding resource region.

### 3) Beam Reporting Resource Region Configuration Method and Mapping Method of the Resource Region and Beam Information

In methods 1) and 2) of the first disclosure described above, the information about the Tx beam transmitted by UE2 during beam reporting may be information about one Tx beam or information about two or more Tx beams.

The configuration of resources for beam reporting in methods 1) and 2) of the first disclosure described above may be configured per resource pool (RP) and may be shared and used among UEs using the corresponding RP. That is, beam reporting resources may be operated in a resource pool (RP) specific manner. The corresponding configuration information may be indicated via radio resource control (RRC), medium access control-control element (MAC-CE), downlink control information (DCI), or a system information block (SIB), etc. Alternatively, it may be indicated by a combination of the signals.

The configuration of resources for beam reporting in methods 1) and 2) of the first disclosure described above may be configured and operated per UE. That is, beam reporting resources may be operated in a UE specific manner. The corresponding configuration information may be indicated via RRC, MAC-CE, or DCI, etc. Alternatively, it may be indicated by a combination of the signals.

In configuring the resource region for beam reporting of methods 1) and 2) of the first disclosure described above, if the corresponding resource region is associated with a specific Tx beam and/or Rx beam of UE1, the mapping between each orthogonal time/frequency resource region and a beam may be a one-to-one correspondence, or the mapping between combinations of partial or overlapping time/frequency resources and a beam may be a one-to-one correspondence.

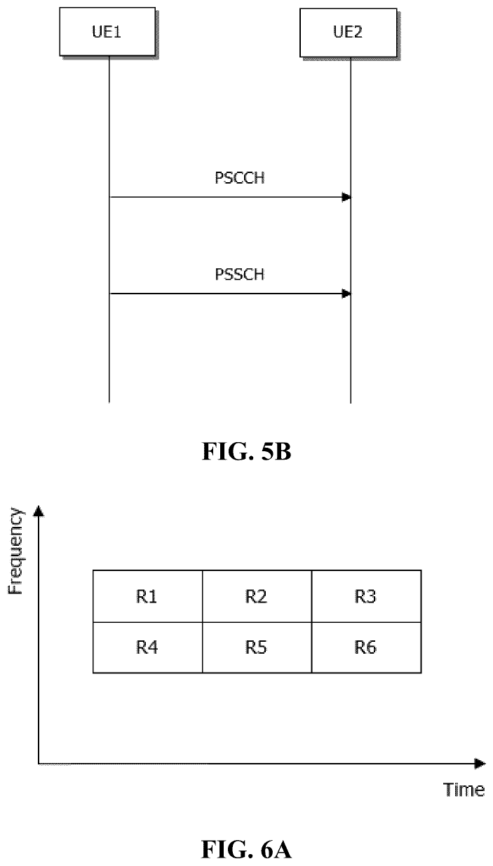

FIGS. 6A to 6B are examples illustrating resource allocation for beam reporting according to an embodiment of this specification.

In FIGS. 6A to 6B, R1, R2, R3, etc., are defined for convenience of explanation as resource units composed of specific time-frequency resources. For example, one resource unit may be composed of time resources such as one or more symbols, mini-slots, or slots, and in the case of frequency, it may be composed of frequency resources such as one or more sub-carriers, resource blocks, or sub-channels. Assume that two resource units are required for one beam reporting transmission. FIG. 6A is an example in which six resource units are allocated, and if resources for beam reporting are allocated to be mutually orthogonal, three occasions may be configured as shown in Table 5.

TABLE 5

| | |
|---|---|
| Occasion #1 | R1, R4 |
| Occasion #2 | R2, R5 |
| Occasion #3 | R3, R6 |

UE2 may repeatedly transmit the beam reporting message up to three times using Occasion #1, Occasion #2, and Occasion #3. The configuration of Table 5 is an example of allocating occasions with mutually orthogonal resources having different time domains, under the assumption that a specific beam is applied for transmission and reception at each time unit during beam sweeping type beam reporting transmission and reception. If there is no beam correspondence, resource allocation in the form of FIG. 6A and Table 5 may be operated to enable repeated transmission of the beam reporting message with a different beam for each occasion. Meanwhile, in FIG. 6B, similarly to FIG. 6A, six resource units from R1 to R6 are a resource region configured for beam reporting. In the case where beam reporting message transmission is possible using two resource units, if resources are allocated to be mutually orthogonal, two occasions may be allocated as in the example of Table 6. In this case, the entire resource units are not used efficiently.

TABLE 6

| | |
|---|---|
| Occasion #1 | R1, R3 |
| Occasion #2 | R2, R4 |

However, if occasions are operated in an overlapping manner without being orthogonal, a maximum of four occasions may be allocated as shown in Table 7.

TABLE 7

| | |
|---|---|
| Occasion #1 | R1, R3 |
| Occasion #2 | R2, R4 |
| Occasion #3 | R3, R5 |
| Occasion #4 | R4, R6 |

In Table 7, Occasion #1 and Occasion #3 overlap with each other, and Occasion #2 and Occasion #4 overlap with each other. If beam correspondence exists, UE2 may operate by transmitting the beam reporting message once in an occasion that is associated with specific Rx beam information of UE1; in this case, resources may be allocated as shown in FIG. 6B and Table 7, and it may be operated to allocate many occasions by a combination of time and frequency resources.

Increasing the number of occasions used in SL communication enables UEs to use more beams in SL communication, that is, enables the use of narrower beams, which may increase performance. Conversely, when operating a fixed number of beams, the resources allocated for beam reporting message transmission may be minimized. For example, resource efficiency may be increased by minimizing the corresponding resources during UE-specific beam reporting resource allocation and operation.

### 4) Beam Correspondence Indication Method in Vehicle-to-Everything (V2X) SL Communication

In V2X SL communication, UE2 may perform an indication to UE1 about whether there is beam correspondence. A beam correspondence indication may be conveyed during the unicast link establishment process or the initial beam pairing process. For example, the beam correspondence indication may be included and transmitted in a direct link establishment accept message that UE2 transmits to UE1 during the unicast link establishment process. Alternatively, the beam correspondence indication may be included and transmitted in a beam reporting message that UE2 transmits to UE1 during the initial beam pairing process.

Second Disclosure: Case where beam-related information is transmitted in a sequence format during beam reporting

All content proposed in this specification for the case where beam-related information is transmitted in a message format during beam reporting may be applied in a simple, extended, modified, or combined form to the case where it is transmitted in a sequence format instead of a beam reporting message.

The case where application is modified compared to message format transmission when beam reporting is transmitted in a sequence format is described as follows.

Since a sequence is not a message, there is no information that may be obtained through decoding, and beam information may be obtained by sequence detection. That is, beam information may be transmitted by a combination of information of the resource region where the sequence was transmitted and the sequence detected in that resource region. Therefore, it is possible to configure an occasion for beam reporting with that combination.

For example, if there are two sequences configured for UE2 to use, and the sequences are mutually orthogonal or semi-orthogonal, occasions may be operated in combination with a sequence as shown in Tables 8 and 9 based on FIGS. 6A and 6B. At this time, the sequence includes an orthogonal sequence form, such as a Zadoff-Chu sequence, where sequences have different cyclic shifts based on the same sequence.

TABLE 8

| | |
|---|---|
| Occasion #1 | R1, R4, sequence #1 |
| Occasion #2 | R2, R5, sequence #1 |
| Occasion #3 | R3, R6, sequence #1 |
| Occasion #4 | R1, R4, sequence #2 |
| Occasion #5 | R2, R5, sequence #2 |
| Occasion #6 | R3, R6, sequence #2 |

In the case of FIG. 6A and Table 8, if there is no beam correspondence, a maximum of two UEs that want to repeatedly transmit the beam reporting message three times may be supported. That is, in Table 5, since message transmission from different users in the same resource region causes interference in the message format, transmission of a beam reporting message for one UE is possible for stable beam reporting message transmission and reception.

Based on the method of Table 8, if there are two UEs, UE2 and UE3, that want to transmit a beam reporting message, Occasion #1, Occasion #2, and Occasion #3 may be allocated to UE2, and Occasion #4, Occasion #5, and Occasion #6 may be allocated to UE3. In this case, stable detection is possible due to the orthogonality of the sequences even in occasions with overlapping resource regions, for example, Occasion #1 and Occasion #4, etc. Therefore, it may be operated to be used by a maximum of two UEs. When operating the resource region for beam reporting in an RP specific manner, in order to allow as many users as possible to use the common resource region, sequence-format beam reporting may be performed, and occasions may be combined and operated in the manner of Table 8.

If the method of FIG. 6A and Table 4 is applied and operated in the case where beam correspondence exists, UE2 may be operated to transmit the beam reporting message once in an occasion associated with specific Rx beam information of UE1. At this time, if the operation of resources for beam reporting transmission is UE specific, UE2 may perform beam reporting through one of the six occasions. That is, increasing the number of occasions used in SL communication enables UEs to use more beams in SL communication, that is, enables the use of narrower beams, which may increase performance. Conversely, when operating a fixed number of beams, the resources allocated for beam reporting message transmission may be minimized. For example, resource efficiency may be increased by minimizing the corresponding resources during UE-specific beam reporting resource allocation and operation.

In the above case, if the operation of resources for beam reporting transmission is RP specific, that is, if there is a UE3 that wants to transmit a beam reporting sequence using the corresponding resource in addition to UE2, each UE may be allocated three occasions in the following form. UE2 may be allocated Occasion #1, Occasion #2, and Occasion #3, and UE3 may be allocated Occasion #4, Occasion #5, and Occasion #6. That is, even if UE2 and UE3 transmit a sequence for beam reporting in the same resource region, by allocating different sequences, they may be allocated and operated to enable detection without mutual interference due to the orthogonality between sequences.

TABLE 9

| | |
|---|---|
| Occasion #1 | R1, R3, sequence #1 |
| Occasion #2 | R2, R4, sequence #1 |
| Occasion #3 | R3, R5, sequence #1 |
| Occasion #4 | R4, R6, sequence #1 |
| Occasion #5 | R1, R3, sequence #2 |
| Occasion #6 | R2, R4, sequence #2 |
| Occasion #7 | R3, R5, sequence #2 |
| Occasion #8 | R4, R6, sequence #2 |

In the case of FIG. 6B and Table 9, a maximum of 8 occasions may be allocated and operated compared to Table 7. If beam correspondence exists, UE2 may operate by transmitting the beam reporting message once in an occasion that is associated with specific Rx beam information of UE1; in this case, resources may be allocated as shown in FIG. 6B and Table 9, and it may be operated to allocate many occasions by a combination of time/frequency resources and sequences.

Increasing the number of occasions used in SL communication enables UEs to use more beams in SL communication, that is, enables the use of narrower beams, which may increase performance. Conversely, when operating a fixed number of beams, the resources allocated for beam reporting message transmission may be minimized. For example, resource efficiency may be increased by minimizing the corresponding resources during UE-specific beam reporting resource allocation and operation.

Although arbitrary time/frequency resources and sequence resources are set in FIGS. 6A to 6B and Tables 5 to 9 for convenience of explanation, all content proposed in this specification may be applied and operated in a simple, modified, or extended form in an SL communication environment.

Furthermore, although this specification is described based on a 5G NR system, all cases where the concepts disclosed herein are applied, regardless of the specific wireless communication technology, may be included in the scope of this specification.

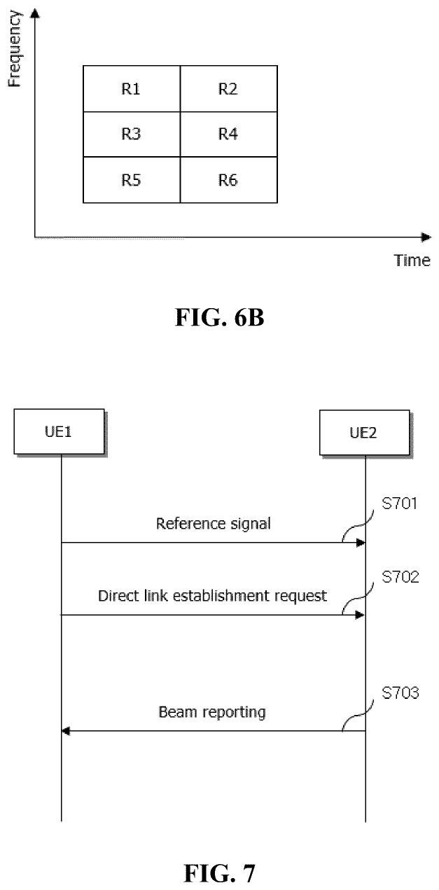

FIG. 7 is an example of signaling for beam reporting for initial beam pairing according to an embodiment of this specification.

Referring to FIG. 7, a receiving terminal (UE2) receives at least one of a reference signal (RS) and a direct link establishment request (DCR) message from a transmitting terminal (UE1) (S701, S702).

Thereafter, the receiving terminal (UE2) determines a transmission beam of the transmitting terminal and a reception beam of the receiving terminal based on the received reference signal or direct link establishment request message, and transmits beam reporting including information about at least one of the transmission beam of the transmitting terminal and the reception beam of the receiving terminal to the transmitting terminal (UE1) (S703). Here, the resource on which the beam reporting is transmitted is associated with at least one of a transmission beam of the transmitting terminal and a reception beam.

The resource on which the beam reporting is transmitted may be resource pool specific or terminal specific.

Meanwhile, the beam reporting may be repeatedly transmitted from the receiving terminal and received by the transmitting terminal. That is, the beam reporting may be repeatedly transmitted via the resource on which the beam reporting is transmitted.

On the other hand, the beam reporting may be transmitted and received via a physical sidelink control channel (PSCCH), a physical sidelink shared channel (PSSCH), or a physical sidelink feedback channel (PSFCH). Here, the beam reporting transmitted via the PSCCH or the PSSCH may be in a message format, and the beam reporting transmitted via the PSFCH may be in a sequence format.

Hereinafter, an apparatus to which the present specification may be applied will be described.

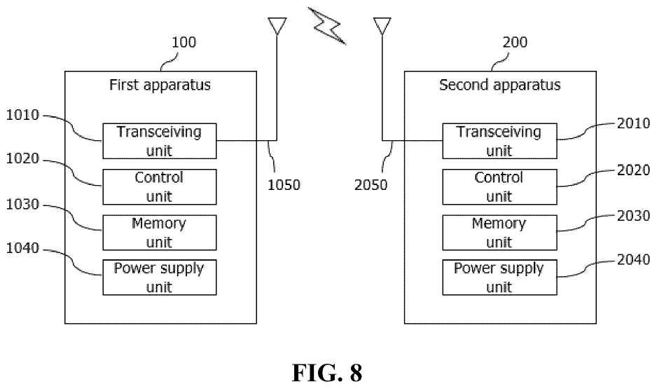

FIG. 8 illustrates a wireless communication apparatus according to an embodiment of the present specification.

Referring to FIG. 8, a wireless communication system may include a first apparatus (100) and a second apparatus (200).

The first apparatus (100) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The second apparatus (200) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The first apparatus (100) may include at least one processor such as a control unit (1020), at least one memory such as a memory unit (1030), and at least one transceiver such as a transceiver unit (1010). It may further include a power supply unit (1040) for supplying and controlling power to the control unit (1020), the memory unit (1030), and/or the transceiver unit (1010). The control unit (1020) may perform the functions, procedures, and/or methods described above. The control unit (1020) may execute one or more protocols. For example, the control unit (1020) may execute one or more layers of a wireless interface protocol. The memory unit (1030) is connected to the control unit (1020) and may store various types of information and/or instructions. The transceiver unit (1010) is connected to the control unit (1020) and may be controlled to transmit and receive wireless signals.

The second apparatus (200) may include at least one processor such as a control unit (2020), at least one memory such as a memory unit (2030), and at least one transceiver such as a transceiver unit (2010). It may further include a power supply unit (2040) for supplying and controlling power to the control unit (2020), the memory unit (2030), and/or the transceiver unit (2010). The control unit (2020) may perform the functions, procedures, and/or methods described above. The control unit (2020) may execute one or more protocols. For example, the control unit (2020) may execute one or more layers of a wireless interface protocol. The memory unit (2030) is connected to the control unit (2020) and may store various types of information and/or instructions. The transceiver unit (2010) is connected to the control unit (2020) and may be controlled to transmit and receive wireless signals.

The memory unit (1030) and/or the memory unit (2030) may be connected internally or externally to the control unit (1020) and/or the control unit (2020), respectively, and may also be connected to other control units through various technologies such as wired or wireless connections.

The first apparatus (100) and/or the second apparatus (200) may have one or more antennas. For example, the antenna (1050) and/or the antenna (2050) may be configured to transmit and receive wireless signals.

While preferred embodiments have been exemplarily described above, the disclosure of this specification is not limited to these specific embodiments, and thus may be modified, changed, or improved in various forms within the spirit of this specification and the scope described in the claims.

What is claimed is:

1. A method of a receiving terminal for performing sidelink communication, the method comprising:
receiving a reference signal (RS) or a direct link establishment request message;
determining, based on the reference signal or the direct link establishment request message, a transmission beam of a transmitting terminal and a reception beam of the receiving terminal; and
transmitting a beam reporting comprising information about the transmission beam of the transmitting terminal or the reception beam of the receiving terminal,
wherein a resource on which the beam reporting is transmitted is associated with the transmission beam of the transmitting terminal or a reception beam of the transmitting terminal.

2. The method of claim 1, wherein the resource on which the beam reporting is transmitted is resource pool specific or terminal specific.

3. The method of claim 1, wherein the beam reporting is repeatedly transmitted via the resource on which the beam reporting is transmitted.

4. The method of claim 1, wherein the beam reporting is transmitted via a physical sidelink control channel (PSCCH), a physical sidelink shared channel (PSSCH), or a physical sidelink feedback channel (PSFCH).

5. The method of claim 4, wherein the beam reporting transmitted via the PSCCH or the PSSCH is in a message format, and the beam reporting transmitted via the PSFCH is in a sequence format.

6. A method of a transmitting terminal for performing sidelink communication, the method comprising:
transmitting a reference signal (RS) or a direct link establishment request message; and
receiving beam reporting comprising information about a transmission beam of the transmitting terminal or a reception beam of a receiving terminal based on the reference signal or the direct link establishment request message,
wherein a resource on which the beam reporting is received is associated with the transmission beam or a reception beam of the transmitting terminal.

7. The method of claim 6, wherein the resource on which the beam reporting is received is resource pool specific or terminal specific.

8. The method of claim 6, wherein the beam reporting is received via repeated transmission from the receiving terminal.

9. The method of claim 6, wherein the beam reporting is received via a physical sidelink control channel (PSCCH), a physical sidelink shared channel (PSSCH), or a physical sidelink feedback channel (PSFCH).

10. The method of claim 9, wherein the beam reporting received via the PSCCH or the PSSCH is in a message format, and the beam reporting received via the PSFCH is in a sequence format.

11. A receiving terminal for performing sidelink communication, comprising:
a control unit; and
a memory unit to store instructions and to operably and electrically connect with the control unit, wherein the instructions, when executed by the control unit, are configured to perform operations comprising:
receiving a reference signal (RS) or a direct link establishment request message;
determining, based on the reference signal or the direct link establishment request message, a transmission beam of a transmitting terminal and a reception beam of the receiving terminal; and
transmitting beam reporting comprising information about the transmission beam of the transmitting terminal or the reception beam of the receiving terminal,
wherein a resource on which the beam reporting is transmitted is associated with the transmission beam or a reception beam of the transmitting terminal.

12. The receiving terminal of claim 11, wherein the resource on which the beam reporting is transmitted is resource pool specific or terminal specific.

13. The receiving terminal of claim 11, wherein the beam reporting is repeatedly transmitted via the resource on which the beam reporting is transmitted.

14. The receiving terminal of claim 11, wherein the beam reporting is transmitted via a physical sidelink control channel (PSCCH), a physical sidelink shared channel (PSSCH), or a physical sidelink feedback channel (PSFCH).

15. The receiving terminal of claim 14, wherein the beam reporting transmitted via the PSCCH or the PSSCH is in a message format, and the beam reporting transmitted via the PSFCH is in a sequence format.

16. A transmitting terminal for performing sidelink communication, comprising:
a control unit; and
a memory unit to store instructions and to operably and electrically connect with the control unit,
wherein the instructions, when executed by the control unit, are configured to perform operations comprising:
transmitting a reference signal (RS) or a direct link establishment request message; and
receiving beam reporting comprising information about a transmission beam of the transmitting terminal or a reception beam of a receiving terminal based on the reference signal or the direct link establishment request message,
wherein a resource on which the beam reporting is received is associated with the transmission beam or a reception beam of the transmitting terminal.

17. The transmitting terminal of claim 16, wherein the resource on which the beam reporting is received is resource pool specific or terminal specific.

18. The transmitting terminal of claim 16, wherein the beam reporting is received via repeated transmission from the receiving terminal.

19. The transmitting terminal of claim 16, wherein the beam reporting is received via a physical sidelink control channel (PSCCH), a physical sidelink shared channel (PSSCH), or a physical sidelink feedback channel (PSFCH).

20. The transmitting terminal of claim 19, wherein the beam reporting received via the PSCCH or the PSSCH is in a message format, and the beam reporting received via the PSFCH is in a sequence format.
